(19) United States
(12) Patent Application Publication
(10) Pub. No.: US 2019/0321962 A1
(43) Pub. Date: Oct. 24, 2019

(54) Slide Handle

(71) Applicant: Jen-Kai Li, Taichung City (TW)

(72) Inventor: Jen-Kai Li, Taichung City (TW)

(21) Appl. No.: 16/388,973

(22) Filed: Apr. 19, 2019

(30) Foreign Application Priority Data
Apr. 20, 2018 (TW) 107113578

(51) Int. Cl. B25G 1/06

(52) U.S. Cl. CPC B25G 1/063; B25B 13/06

(57) ABSTRACT

The present disclosure provides a slide handle which has a first hole penetrating a top portion of a main body of the slide handle. A lever passes slidably through the first hole. A fixation mechanism includes at least one fixing groove which is formed on a surrounding surface of the lever and a second hole which penetrates the top portion of the main body. The central axes of the second hole and the first hole are skew lines. The second hole intersects the first hole partially, and a wall of the second hole is connected to a wall of the first hole. Furthermore, the fixation mechanism has a resilient member and a fixing member which are located in the second hole. The fixing member can partially protrude into the first hole. The fixing member can be pushed to move axially in the second hole to engage or disengage the fixing groove on the lever. Therefore, the position of the main body relative to the lever is adjustable, and both the volume of the main body and the manufacturing costs of the slide handle can be reduced.

### RELATED APPLICATIONS

This application claims priority to Taiwan Application Serial Number 107113578, filed on Apr. 20, 2018, which is herein incorporated by reference.

### FIELD OF THE INVENTION

The present disclosure relates to a slide handle, and the slide handle has a lever that passes through a main body, and the position of the main body relative to the lever is adjustable by a fixation mechanism.

### BACKGROUND OF THE INVENTION

Nowadays, a slide handle is used together with the socket when the bolts of a large item need to be installed and uninstalled. The slide handle includes a main body and a lever. A lateral hole penetrates a top portion of the main body. The top portion is connected to a driving portion which can put a socket thereon, and the driving portion is provided with a limiting member which can engage the socket. The lever passes through the lateral hole of the main body. Therefore, the lever can rotate the main body and the socket to install and uninstall a bolt. The operating length of the lever is adjustable according to the different operating spaces. The slide handle includes a locking mechanism to prevent the lever from sliding randomly in the lateral hole, so that the operating length of the lever can be controlled and the safety is increased during operation.

The invention of TW Pat. No. M317907, as shown in FIG. 1, includes a main body 11 and a lever 12. A lateral hole 111 penetrates a top portion of the main body 11. The top portion is connected to a driving portion 112 which has the shape of a square prism, and the driving portion 112 is provided with a limiting member 113 which can engage the socket (not shown). The lever 12 which has restricting grooves 121 at both ends passes through the lateral hole 111 of the main body 11. Each restricting groove 121 has a restricting ball 122 which is embedded in the restricting groove 121 to prevent the main body 11 from sliding off the lever 12. There is a locking mechanism between the main body 11 and the lever 12. The locking mechanism has an accommodating hole 114 which is located at the main body 11. The accommodating hole 114 communicates with the lateral hole 111. A spring 13 and a locking member 14 are placed in the accommodating hole 114, and the locking member 14 can move up and down in the accommodating hole 114 because of the rebound and compressing of the spring 13. The locking member 14 can protrude into the lateral hole 111 when the locking member 14 is pushed by the rebound of the spring 13. The locking mechanism has several locking holes 123 which are located at the lever 12. When the main body 11 slides along the lever 12, the locking member 14 is pressed to retract into the accommodating hole 114 by the surrounding surface of the lever 12, and the locking member 14 further compresses the spring 13. When the main body 11 slides to the position of the locking holes 123, the locking member 14 can be pushed by the rebound of the spring 13 to engage the locking hole 123, so that the main body 11 can be locked on the lever 12. To ensure that the main body 11 can be stably locked on the lever 12, the spring 13 with a large spring force would be used. Therefore, the locking member 14 cannot easily retract into the accommodating hole 114 because the spring 13 cannot be compressed easily. Hence, when a user wants to adjust the position of the main body 11, the user must apply a considerable force to make the main body 11 slide along the lever 12 to retract the locking member 14 into the accommodating hole 114. Therefore, the operation of the slide handle is time-consuming and inconvenient.

The slide handle 20 of the invention of TW Pat. No. M468382, as shown in FIG. 2 to FIG. 4, includes a main body 21, a lever 22, and a control mechanism. A lateral hole 211 penetrates a top portion of the main body 21. The top portion is connected to a driving portion 212 which has the shape of a square prism, and the driving portion 212 can put a socket thereon. The lever 22 passes through the lateral hole 211 of the main body 21. The control mechanism has a sliding groove 221 on the surrounding surface of the lever 22. Both ends of the sliding groove 221 is closed, and each end of the sliding groove 221 has a restricting recess 222. The sliding groove 221 has several locking recesses 223. The depth of the locking recess 223 is different from that of the sliding groove 221. Furthermore, the control mechanism includes an accepting hole 213, a control member 23, and a spring 24. The accepting hole 213 has a doughnut surface 2131 at one end, and the other end is closed. The control member 23 is placed in the accepting hole 213 and has a first groove 231 on the surrounding surface of the control member 23. The surrounding surface of the control member 23 is taken as a first contacting surface 232. The control member 23 has a bulging end 233 which can abut the doughnut surface 2131. The control member 23 can move forwards and backwards in the accepting hole 213 because of the rebound and compressing of the spring 24. A first restraining member 25 is located between the control member 23 and the lever 22, and the first contacting surface 232 of the control member 23 can push the first restraining member 25 to engage the locking recess 223 of the lever 22.

Please refer to FIG. 5. When a user wants to adjust the position of the main body 21 relative to the lever 22, the user can push the control member 23 inward into the accepting hole 213 of the main body 21. When the first groove 231 which is pushed along with the control member 23 moves to the position of the first restraining member 25, the first contacting surface 232 of the control member 23 cannot push the first restraining member 25, and a part of the first restraining member 25 can radially retract into the first groove 231 of the control member 23. Therefore, the first restraining member 25 would disengage the locking recess 223 of the lever 22, and the main body 21 can slide along the lever 22 to adjust the position of the main body 21 relative to the lever 22. Please refer to FIG. 6. When the main body 21 slides to the position of the locking recess 223A, the user releases the control member 23, and the rebound of the spring 24 pushes the control member 23 back to the original position. Therefore, the first contacting surface 232 of the control member 23 can push the first restraining member 25 to engage the locking recess 223A of the lever 22. Then the user can rotate lever 22 to further install and uninstall a bolt.

Please refer to FIG. 5 and FIG. 6. The control member 23 moves axially in the accepting hole 213 to make the first restraining member 25 move radially to engage or disengage the locking recess 223. Therefore, the main body 21 needs an additional space for the radial movement of the first restraining member 25. The volume of the top portion of the main body 21 must be large enough to contain the additional space, and the increased volume of the main body 21 not only waste materials but also make the slide handle more cumbersome. Furthermore, the control member 23 needs the first groove 231 for the radial retraction of the first restraining member 25. The machining processes of the first groove 231 on the control member 23 would increase the manufacturing costs of the control member 23. Therefore, the slide handle 20 still needs to be improved.

The present invention is, therefore, arisen to obviate or at least mitigate the above mentioned disadvantages.

### SUMMARY OF THE INVENTION

One of the objects of the present invention is to provide a slide handle which is easy to be operated. A first hole penetrates a top portion of a main body of the slide handle. A lever passes slidably through the first hole. A fixation mechanism includes at least one fixing groove which is formed on a surrounding surface of the lever. The fixation mechanism has a second hole which penetrates the top portion of the main body. The central axes of the second hole and the first hole are skew lines. The second hole intersects the first hole partially, and a wall of the second hole is connected to a wall of the first hole. Furthermore, the fixation mechanism has a resilient member and a fixing member which are located in the second hole. The fixing member can partially protrude into the first hole. The fixing member can be easily pushed to move axially in the second hole to engage or disengage the fixing groove on the lever, so that a user can easily adjust the position of the main body relative to the lever. Therefore, the operation of the slide handle is convenient.

Another object of the present invention is to provide a slide handle which can be reduced in weight. The slide handle has the second hole which intersects the first hole partially, and a wall of the second hole is connected to a wall of the first hole. Therefore, the fixing member can be pushed to move axially in the second hole to engage or disengage the fixing groove on the lever. Because the fixing member does not have to move radially, the main body does not need an additional space for the radial movement of the fixing member. Therefore, the volume of the main body can be reduced, so that the weight of the slide handle can be reduced.

Still another object of the present invention is to provide a slide handle which can reduced the manufacturing costs. The slide handle has the second hole which intersects the first hole partially, and a wall of the second hole is connected to a wall of the first hole. Therefore, the fixing member can be pushed to move axially in the second hole to engage or disengage the fixing groove on the lever. Because the fixing member does not have to radially retract, the fixation mechanism does not need a groove for the radial retraction of the fixing member. Therefore, the machining processes of the slide handle can be reduced, so that the manufacturing costs can be reduced.

### BRIEF DESCRIPTION OF THE DRAWINGS

The present disclosure can be more fully understood by reading the following detailed description of the embodiment, with reference made to the accompanying drawings as follows:

FIG. 1 is a section view showing an invention of TW Pat. No. M317907;

FIG. 2 is a stereogram showing an invention of TW Pat. No. M468382;

FIG. 3 is an exploded view showing an invention of TW Pat. No. M468382;

FIG. 4 is a section view showing an invention of TW Pat. No. M468382;

FIG. 5 to FIG. 6 are the schematic views showing the operation process of an invention of TW Pat. No. M468382;

FIG. 7 is an exploded view showing a first embodiment of the present invention;

FIG. 8 is a stereogram showing a first embodiment of the present invention;

FIG. 9 is a section view showing a first embodiment of the present invention;

FIG. 10 is the schematic view (1) showing the operation process of a first embodiment of the present invention;

FIG. 11 is a section view of FIG. 10;

FIG. 12 is the schematic view (2) showing the operation process of a first embodiment of the present invention;

FIG. 13 is a section view of FIG. 12;

FIG. 14 is the schematic view (3) showing the operation process of a first embodiment of the present invention;

FIG. 15 is a section view of FIG. 14;

FIG. 16 an exploded view showing a second embodiment of the present invention;

FIG. 17 is a stereogram showing a second embodiment of the present invention;

FIG. 18 is a section view showing a second embodiment of the present invention.

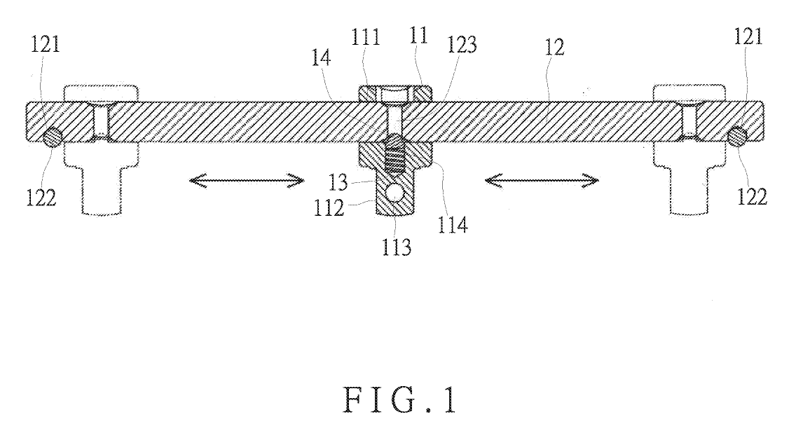

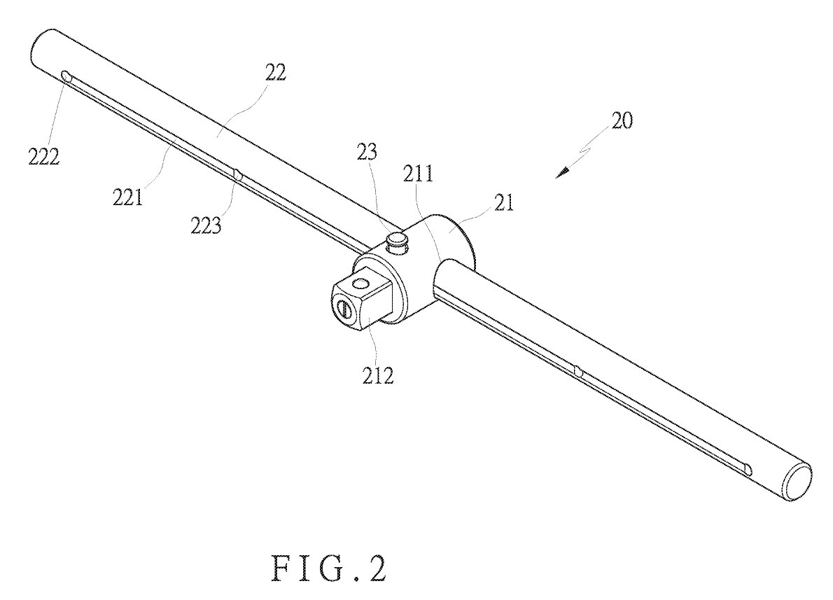

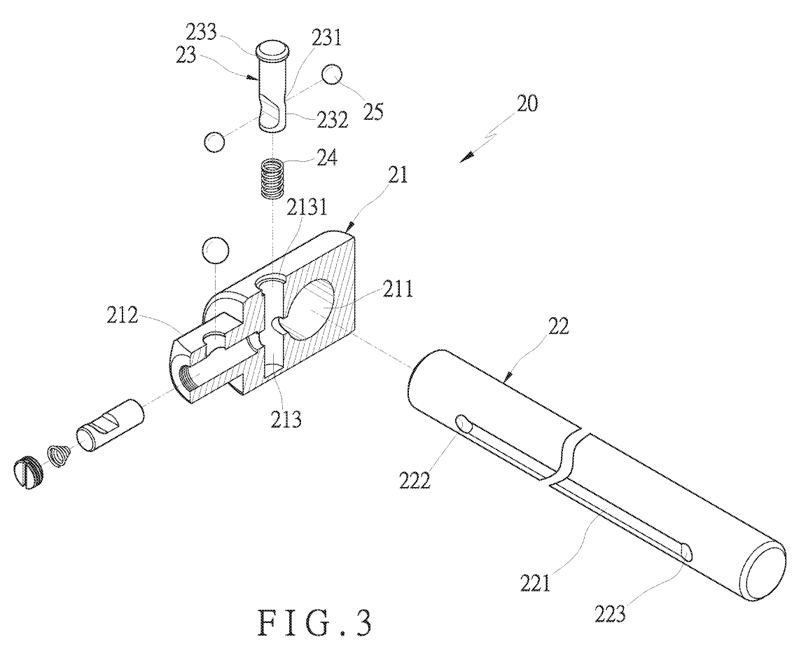

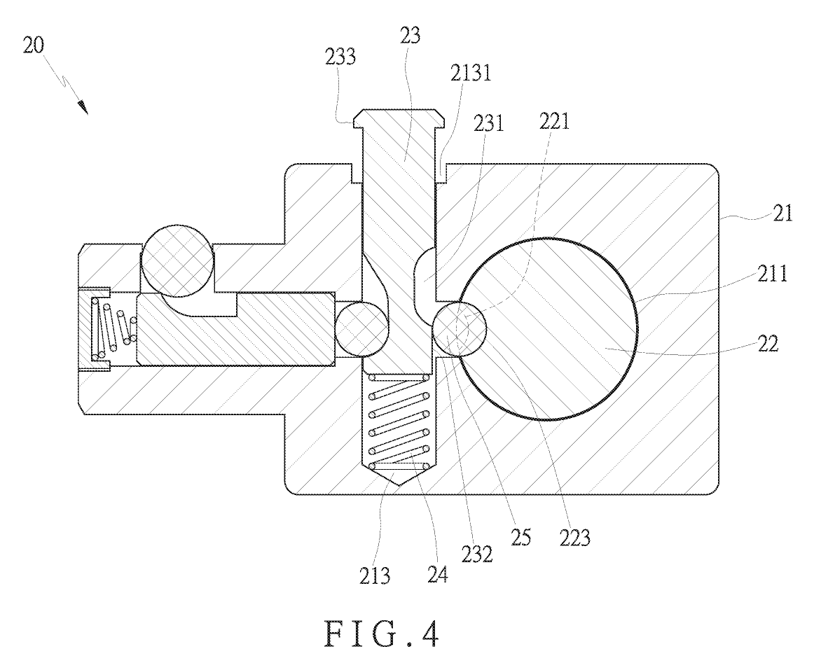

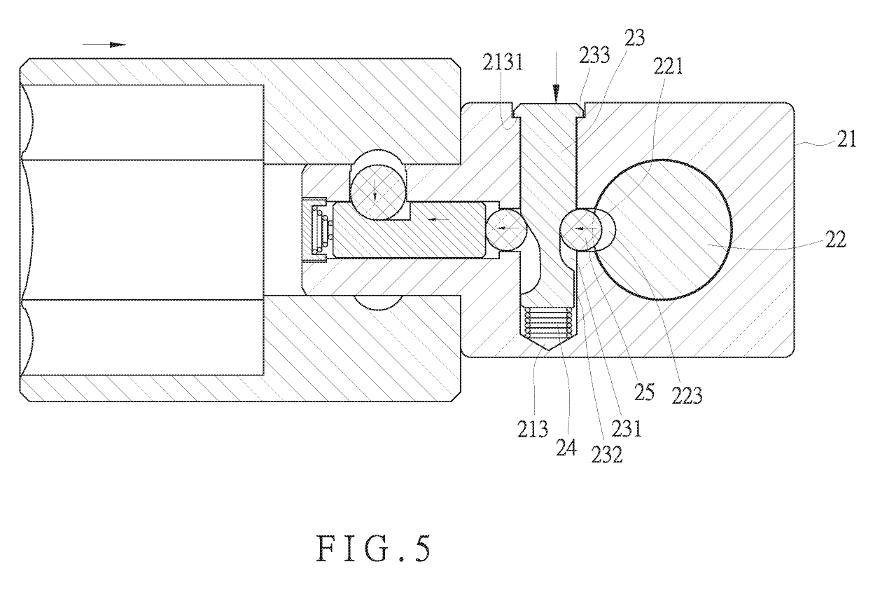

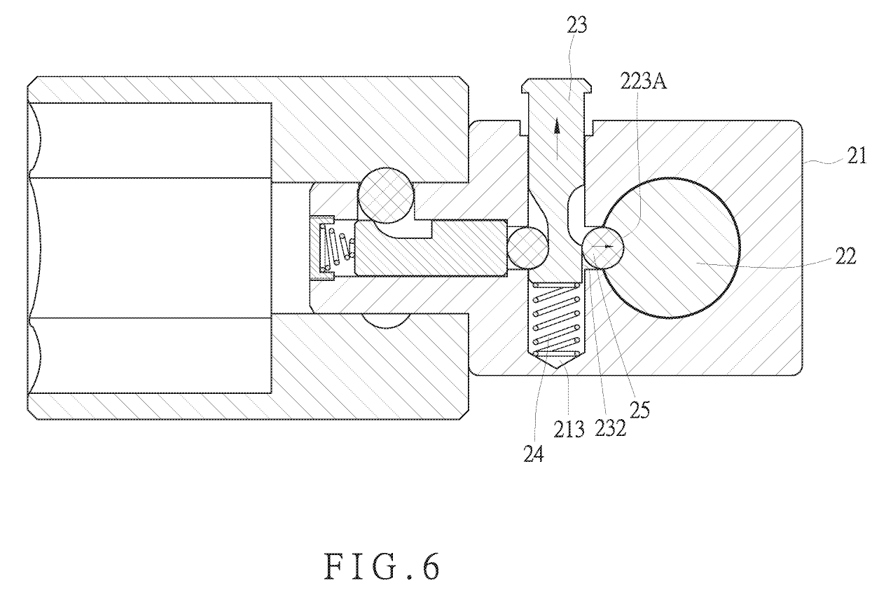

### DETAILED DESCRIPTION OF THE PREFERRED EMBODIMENTS

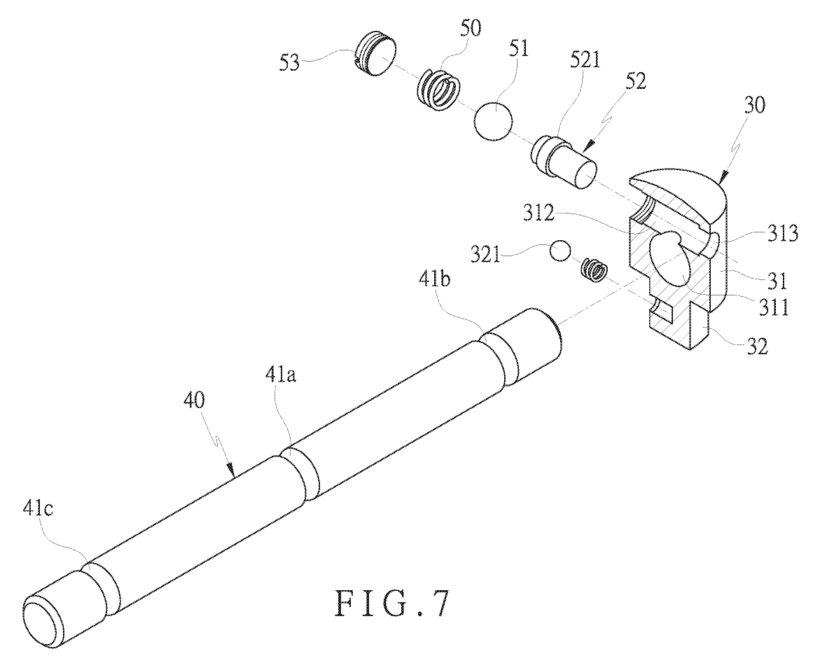

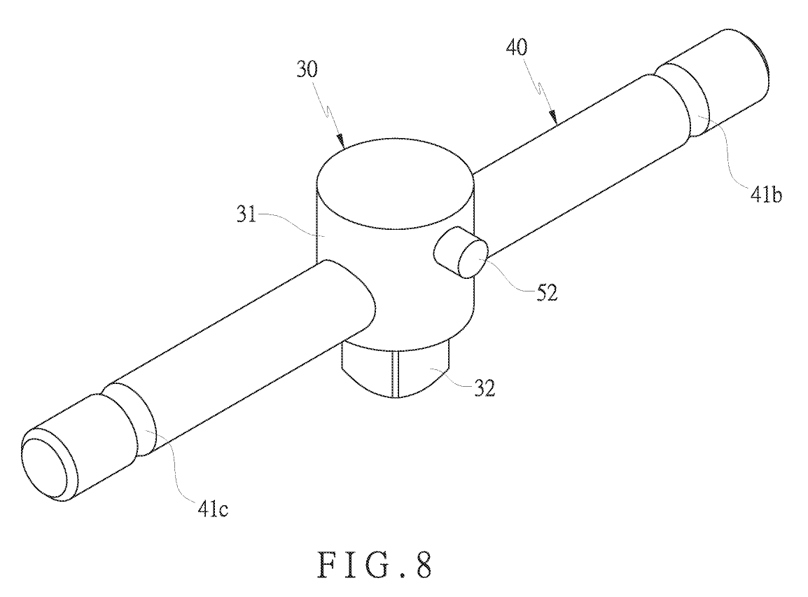

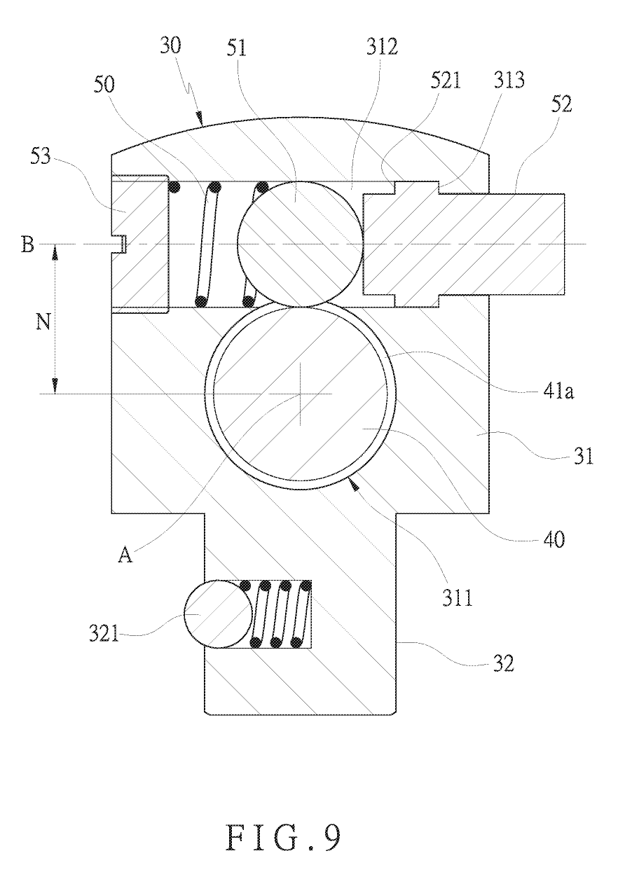

Please refer to FIG. 7 to FIG. 9. A first embodiment of the present invention includes a main body 30, a lever 40, and a fixation mechanism. The main body 30 has a top portion 31 and a driving portion 32. The driving portion 32 is connected to the top portion 31. A first hole 311 which is a circular hole penetrates the top portion 31. The driving portion 32 can put a socket thereon, and the driving portion 32 is provided with a ball 321 which can engage the socket. There are many conventional skills regarding the engaging mechanism between the ball 321 and the socket, and the engaging mechanism is not the point of the present invention. Therefore, the engaging mechanism between the ball 321 and the socket would not be described here. The lever 40 passes through the first hole 311 of the main body 30, so that the main body 30 can slide along the lever 40 to adjust the position of the main body 30 relative to the lever 40. Therefore, the operating length of the lever 40 is adjustable according to the different environmental operating spaces.

The fixation mechanism has at least one fixing groove. In this embodiment, the fixation mechanism has fixing grooves 41a, 41b, and 41c which are spaced apart from each other on the surrounding surface of the lever 40, and each fixing groove is annular. The fixation mechanism further has a second hole 312 which is a circular hole. The second hole 312 penetrates the top portion 31 of the main body 30. A central axis B of the second hole 312 and a central axis A of the first hole 311 are skew lines. A distance N between the central axis B and the central axis A is smaller than a summation of radii of the second hole 312 and the first hole 311. Therefore, the second hole 312 intersects the first hole 311 partially, and an overlap between the second hole 312 and the first hole 311 forms a communication hole. A wall of the second hole 312 is connected to a wall of the first hole 311 at a periphery of the communication hole. Furthermore, the fixation mechanism has a resilient member 50, a fixing member 51, and a pressing member 52 which are located in the second hole 312. The pressing member 52 protrudes axially from the top portion 31. A part of the fixing member 51 can fall into the communication hole, so that the fixing member 51 can radially protrude into the first hole 311. When the fixing member 51 is pushed axially by the pressing member 52 or the resilient member 50, the fixing member 51 can move axially along the second hole 312 to engage or disengage one of the fixing grooves 41a, 41b, and 41c on the lever 40. The second hole 312 has a stepped surface 313 at a first end of the second hole 312, and the pressing member 52 has an annular stepped stopper 521. Therefore, the annular stepped stopper 521 of the pressing member 52 can abut against the stepped surface 313 when the pressing member 52 passes through the second hole 312 from the second end of the second hole 312, so that the pressing member 52 can stay in the second hole 312 and protrude axially from the top portion 31. Next, the fixing member 51 is put into the second hole 312 from the second end of the second hole 312 and the fixing member 51 protrudes radially into the first hole 311. Then the resilient member 50 is put into the second hole 312 from the second end of the second hole 312 and abuts against the fixing member 51. Finally, a sealing member 53 is attached and secured to the second end of the second hole 312 to keep the pressing member 52, the fixing member 51, and the resilient member 50 in the second hole. In addition, a diameter of the fixing member 51 is slightly smaller than a diameter of the second hole 312.

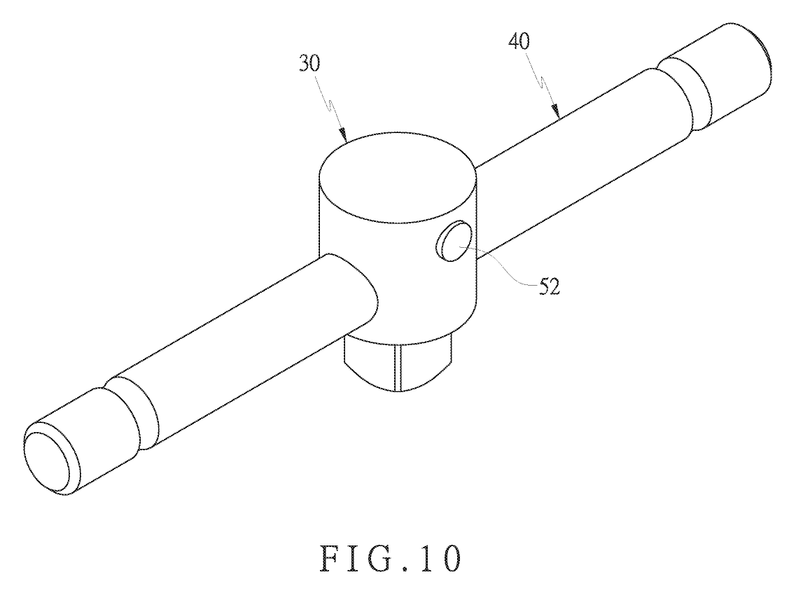

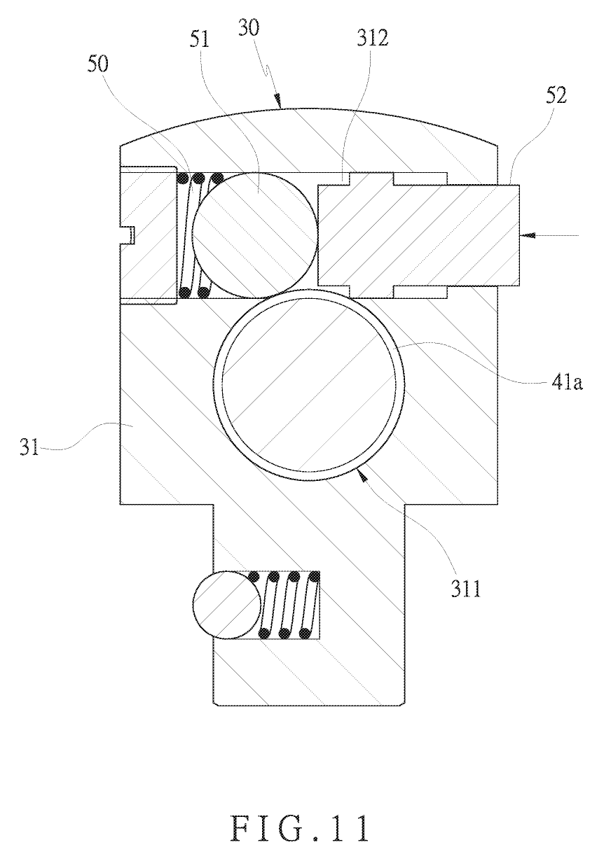

Please refer to FIG. 10 and FIG. 11. When a user pushes the pressing member 52 of a first embodiment of the present invention, the pressing member 52 can further push the fixing member 51 to move axially, leading compression of the resilient member 50. Hence, the fixing member 51 would retreat and move away from the communication hole, so that the fixing member 51 would not protrude radially into the first hole 311. Therefore, the fixing member 51 can disengage the fixing groove 41a on the lever 40, and the user can slide the main body 30 along the lever 40 to adjust the position of the main body 30 relative to the lever 40.

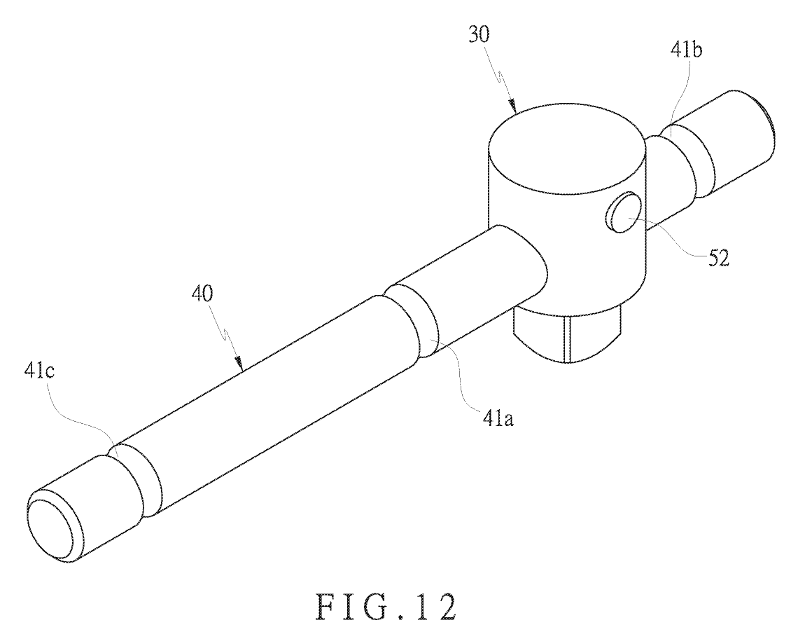

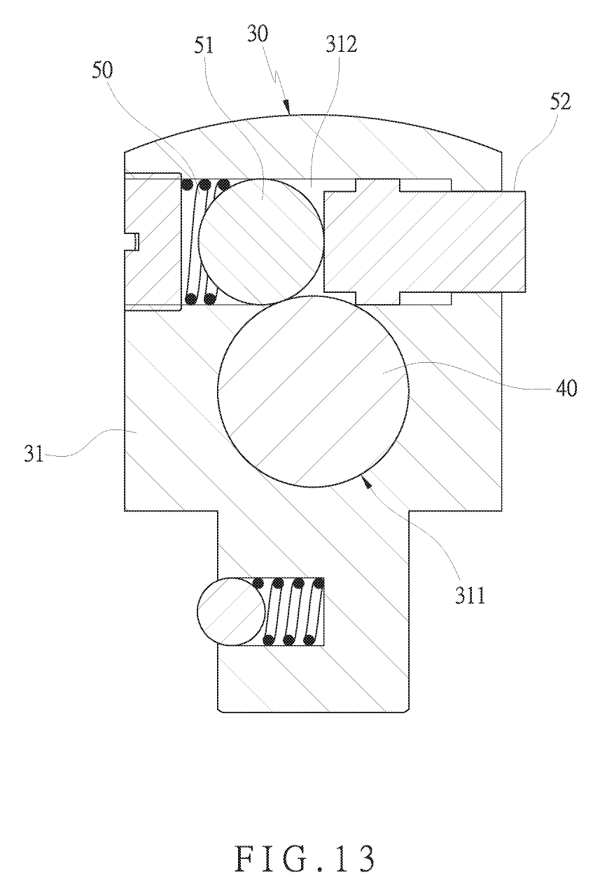

Please refer to FIG. 12 and FIG. 13. When the fixing member 51 moves away from the communication hole and the main body 30 slides along the lever 40, the surrounding surface of the lever 40 protrudes radially into the second hole 312 through the communication hole. Therefore, the surrounding surface of the lever 40 holds the fixing member 51 at the position of compressing the resilient member 50. At this time, the user can release the pressing member 52 and continue to slide the main body 30 along the lever 40.

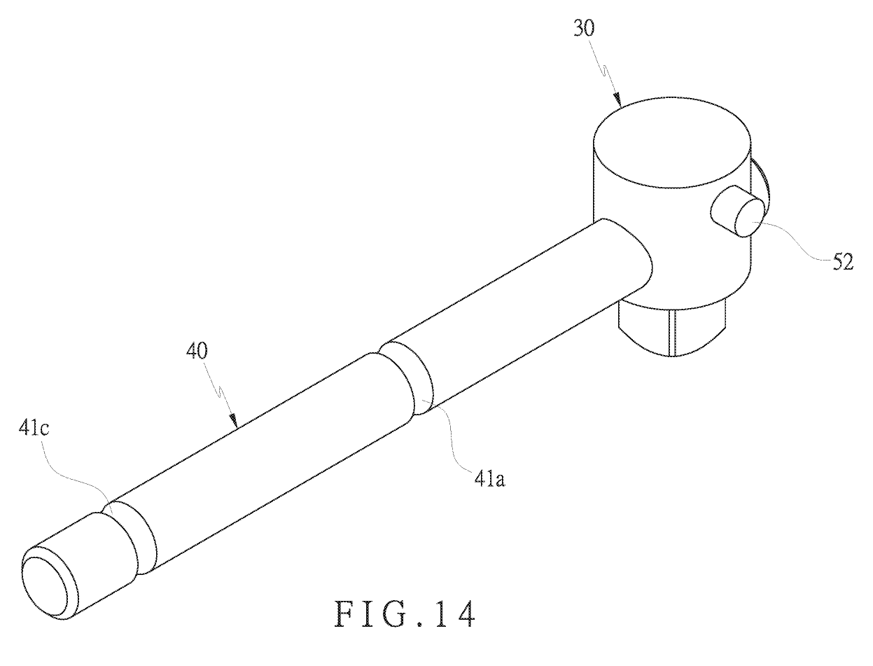

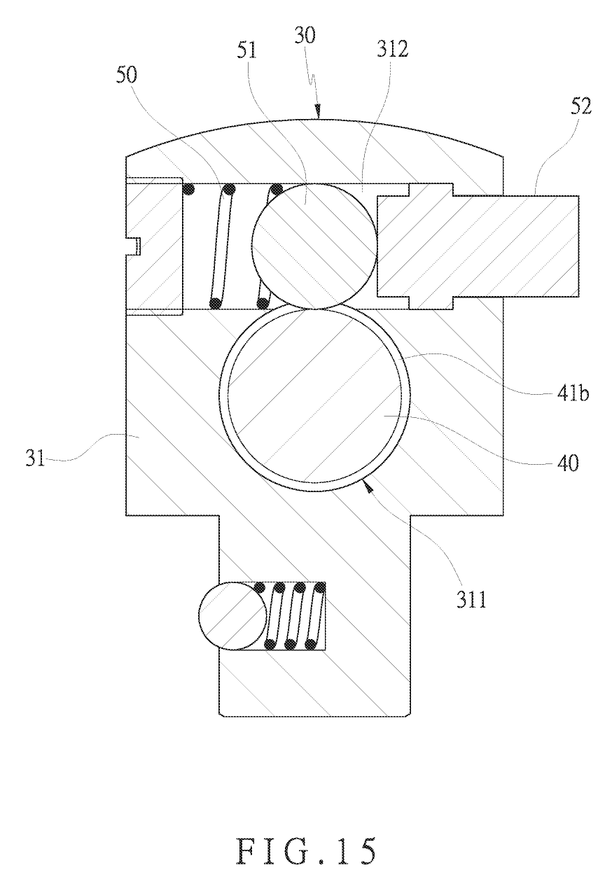

Please refer to FIG. 14 and FIG. 15. When the main body 30 slides to the position of the fixing groove 41b, the position of the communication hole would correspond to the position of the other fixing groove 41b instead of the surrounding surface of the lever 40. Therefore, the surrounding surface of the lever 40 could not hold the fixing member 51 at the position of compressing the resilient member 50, and the rebound of the resilient member 50 would axially push the fixing member 51. The moving of the fixing member 51 further pushes the pressing member 52, and the fixing member 51 would stop moving when the annular stepped stopper 521 of the pressing member 52 abuts the stepped surface 313 of the second hole 312. At this time, a part of the fixing member 51 falls into the communication hole, so that the fixing member 51 radially protrudes into the first hole 311 to engage the fixing groove 41b and make the main body 30 stay at the position of the fixing groove 41b on the lever 40.

The fixing member 51 can be easily pushed by the pressing member 52 or the resilient member 50 to move axially to engage or disengage one of the fixing grooves on the lever 40, so that a user can easily adjust the position of the main body 30 relative to the lever 40. Therefore, the operation of the slide handle is convenient. In addition, the fixing member 51 moves axially, rather than radially, along the second hole. The main body 30 can be provided with a minimized length, since the movement of the fixing member 51 requires no additional radial space. Therefore, the volume of the top portion 31 of the main body 30 can be reduced, so that the weight of the slide handle can be reduced. Furthermore, because the fixing member 51 does not have to radially retract, the pressing member 52 does not need a groove for the radial retraction of the fixing member 51. Therefore, the machining processes of the slide handle can be reduced, so that the manufacturing costs can be reduced.

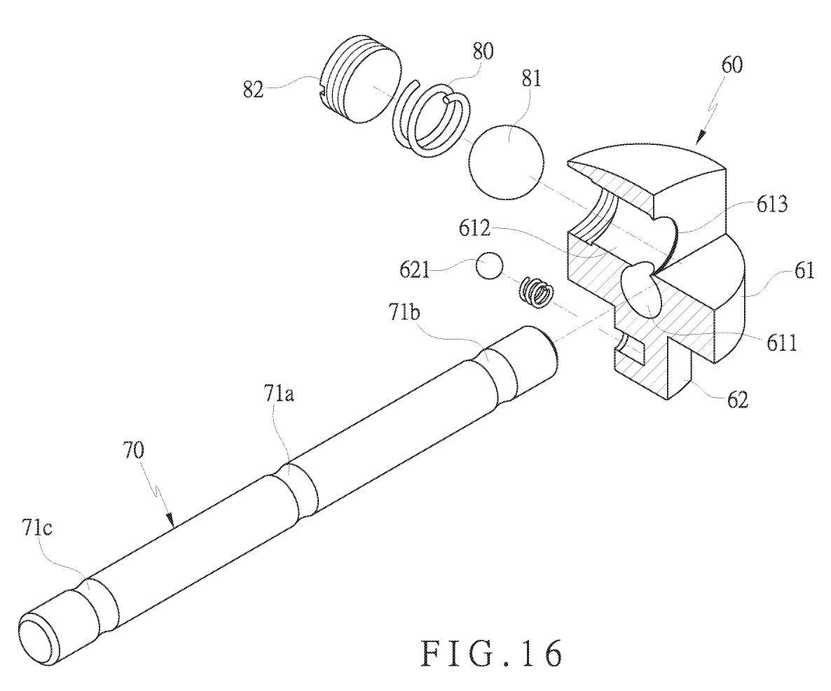

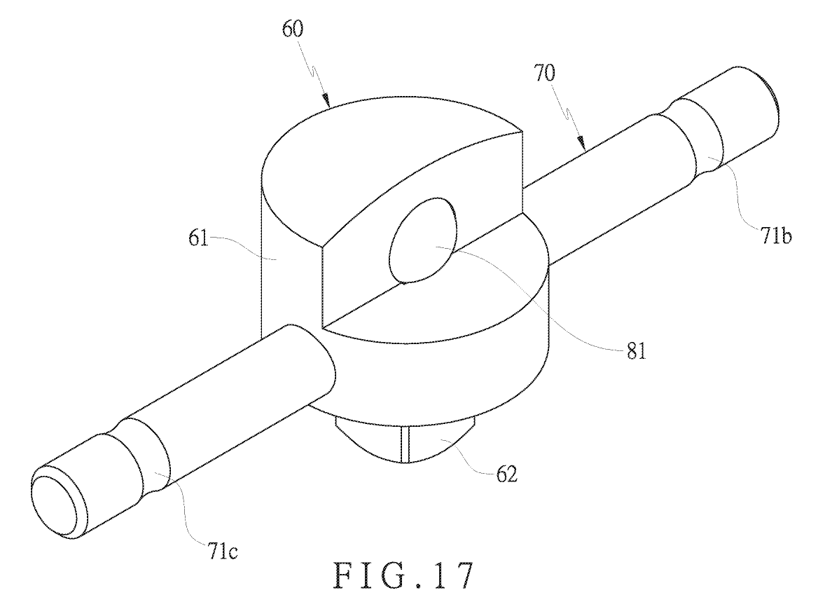

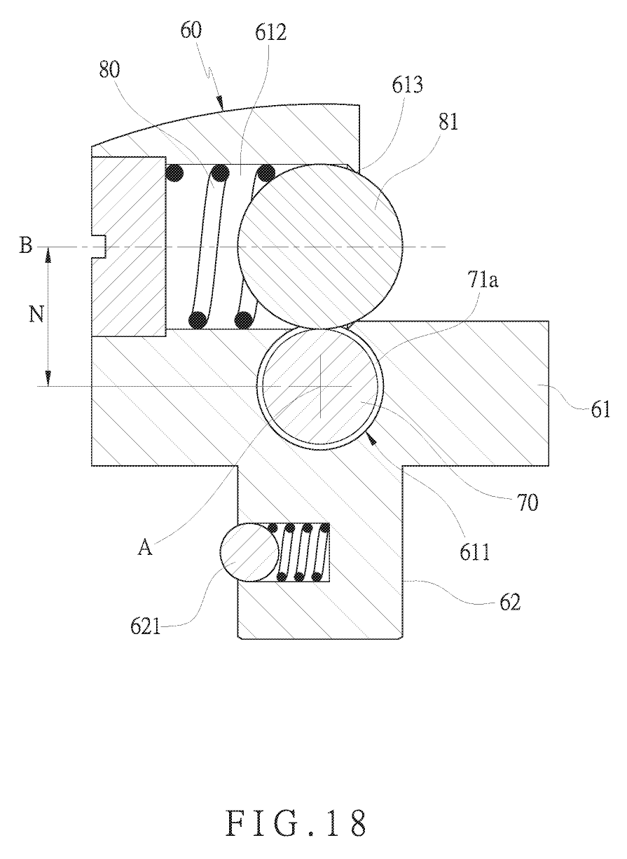

Please refer to FIG. 16 to FIG. 18. A second embodiment of the present invention includes a main body 60, a lever 70, and a fixation mechanism. The main body 60 has a top portion 61 and a driving portion 62. The driving portion 62 is connected to the top portion 61. A first hole 611 which is a circular hole penetrates the large sub-portion of the top portion 61. The driving portion 62 can put a socket thereon, and the driving portion 62 is provided with a ball 621 which can engage the socket. The lever 70 passes through the first hole 611 of the main body 60, so that the main body 60 can slide along the lever 70 to adjust the position the main body 60 relative to the lever 70. Therefore, the operating length of the lever is adjustable according to the different environmental operating spaces.

The fixation mechanism has fixing grooves 71a, 71b, and 71c which are spaced apart from each other on the surrounding surface of the lever 70, and each fixing groove is annular. The fixation mechanism further has a second hole 612 which is a circular hole. The second hole 612 penetrates the small sub-portion of the top portion 61. A central axis B of the second hole 612 and a central axis A of the first hole 611 are skew lines. A distance N between the central axis B and the central axis A is smaller than a summation of radii of the second hole 612 and the first hole 611. Therefore, the second hole 612 intersects the first hole 611 partially, and an overlap between the second hole 612 and the first hole 611 forms a communication hole. A wall of the second hole 612 is connected to a wall of the first hole 611 at a periphery of the communication hole. Furthermore, the fixation mechanism has a resilient member 80 and a fixing member 81 which are located in the second hole 612. A part of the fixing member 81 can fall into the communication hole, so that the fixing member 81 can radially protrude into the first hole 611. The second hole 612 has a stepped surface 613 at a first end of the second hole 612, and the fixing member 81 can abut the stepped surface 613 when the fixing member 81 passes through the second hole 612 from the second end of the second hole 612, so that the fixing member 81 can stay in the second hole 612 and protrude axially from the small sub-portion of the top portion 61. Next, the resilient member 80 is put into the second hole 612 from the second end of the second hole 612 and abuts the fixing member 81. Finally, a sealing member 82 is attached and secured to the second end of the second hole 612 to keep the fixing member 81 and the resilient member 80 in the second hole 612. The fixing member 81 can be pushed by the resilient member 80 or from the outside of the small sub-portion of the top portion 61. Therefore, the fixing member 81 can move axially in the second hole 612 to engage or disengage one of the fixing grooves 71a, 71b, and 71c on the lever 70. In addition, a diameter of the fixing member 81 is slightly smaller than a diameter of the second hole 612. The difference between the second embodiment and the first embodiment of the present invention is that the slide handle of the second embodiment does not include the pressing member as disclosed in the first embodiment. The fixing member 81 of the second embodiment can be directly pushed from the outside of the small sub-portion of the top portion 61 to move axially. Therefore, the second embodiment has an effect similar to that of the first embodiment.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A slide handle, comprising:
a main body, having a top portion and a driving portion, the driving portion being connected to the top portion, a first hole penetrating the top portion;
a lever, passing through the first hole of the main body;
a fixation mechanism, including a fixing groove, a second hole, a resilient member, and a fixing member, the fixing groove being formed on a surrounding surface of the lever, the second hole being a circular hole, the second hole being located at the top portion of the main body, a central axis of the second hole and a central axis of the first hole being skew lines, a distance between the central axis of the second hole and the central axis of the first hole being smaller than a summation of radii of the second hole and the first hole, the second hole intersecting the first hole partially, an overlap between the second hole and the first hole forming a communication hole, a wall of the second hole being connected to a wall of the first hole at a periphery of the communication hole, the resilient member and the fixing member being located in the second hole, a part of the fixing member being able to radially protrude into or retreat from the first hole when the fixing member is pushed to move axially along the second hole for engaging or disengaging the fixing groove on the lever.

2. The slide handle of claim 1, wherein the driving portion of the main body is provided with a ball.

3. The slide handle of claim 1, wherein the first hole of the main body is a circular hole.

4. The slide handle of claim 1, wherein the fixation mechanism has a plurality of fixing grooves which are spaced apart from each other on the surrounding surface of the lever, and each fixing groove is annular.

5. The slide handle of claim 1, wherein the second hole penetrates the top portion of the main body and has a stepped surface at a first end of the second hole, a pressing member which has an annular stepped stopper is located at the first end of the second hole and protrudes axially from the top portion, and the pressing member can axially push the fixing member to move axially in the second hole.

6. The slide handle of claim 5, wherein a sealing member is attached to a second end of the second hole, so that the pressing member, the fixing member, and the resilient member are kept in the second hole.

7. The slide handle of claim 1, wherein the second hole penetrates the top portion of the main body and has a stepped surface at a first end of the second hole, the fixing member is located at the first end of the second hole and protrudes axially from the top portion, and the fixing member can be pushed from an outside of the top portion to move axially in the second hole.

8. The slide handle of claim 7, wherein a sealing member is attached to a second end of the second hole, so that the fixing member and the resilient member are kept in the second hole.

9. The slide handle of claim 1, wherein a diameter of the fixing member is slightly smaller than a diameter of the second hole.
